(19) United States
(12) Patent Application Publication
(10) Pub. No.: US 2011/0127207 A1
(43) Pub. Date: Jun. 2, 2011

(54) FILTER ARRANGEMENT

(75) Inventors: David Stenman, Sala (SE); Eva Ålander, Lidingo (SE)

(73) Assignee: WALLENIUS WATER AKTIEBOLAG, STOCKHOLM (SE)

(21) Appl. No.: 12/993,929

(22) PCT Filed: May 20, 2009
(86) PCT No.: PCT/SE2009/050582

§ 371 Date: Feb. 16, 2011

(30) Foreign Application Priority Data
May 21, 2008 (SE) 0801176-9

(51) Int. Cl. B01D 35/00; C02F 1/32

(52) U.S. Cl. 210/251

(57) ABSTRACT

An arrangement for use in a liquid treatment unit, which includes a generally tubular housing having a liquid inlet in one end and a liquid outlet in the opposite end, a generally tubular filter element arranged generally concentric inside the housing, through which liquid is fed from outside the filter to inside the filter, an elongated UV-generating element arranged inside the filter element, whose longitudinal direction generally corresponds to that of the filter element, material displaying catalytic properties and radiated by UV-light arranged on at least the inner surfaces of the filter element. The elongated UV-generating element extends a further distance than the generally tubular filter element, which extension is positioned adjacent the outlet, wherein the further distance ensures the flow of liquid, that has passed through the filter element, to flow a certain minimum distance along the elongated UV-generating element, thereby exposing the flow of liquid to UV-light.

### TECHNICAL AREA

The present invention relates to a filter arrangement, and in particular to filters with additional functionality.

### TECHNICAL BACKGROUND

There is a need to filter out particles in a large number of processes for treating fluids. The filtering could be an initial step in a treatment process that includes further steps, like purification, sterilization, and the like.

One such area of application is treatment of water. The applicant of the present invention is developing systems for water treatment comprising treatment units working with photocatalytic reactions producing radicals in the water by irradiating a catalyst with UV-light. However, for many applications, the water contains quite a lot of particles of different sizes that have to be filtered before the water is exposed to the oxidation process.

The applicant is constantly striving to increase the efficiency of the water treatment process and has therefore developed a filter arrangement where an AOT process (Advanced Oxidation Technology) is arranged in the filter area. The AOT utilizes three important components for treating water flowing through the filter. One is UV-generating means, i.e. wavelengths within the ultraviolet spectra, <380 nm, of energies sufficient for photocatalysis and/or direct elimination of micro-organisms and/or direct formation of free radicals in the liquid or components dissolved therein and/or direct formation of ozone from oxygen present as gas or dissolved in the liquid. The wavelengths enable the second component which is generating ozone in the water and at the same time breaking down the ozone to form free radicals. The third component is arranging catalysts in the reactive zone where ozone and free radicals are produced, in order to increase the amount of free radicals.

Currently a filter is used that is arranged with filter elements having a tubular shape, through which the water is directed via slits that have a width in the region of 50 μm. The filter is very efficient in removing most particles in the water to be treated. During filtration, the filter becomes more and more clogged. With the present filter design tubular filter elements are positioned vertically inside a housing, which housing is arranged with an inlet at the upper part of the filter elements and an outlet at the lower part of the filter elements. It is however not completely sure that the liquid flowing through the filter elements are exposed during a long enough period of time to be completely treated. For example, it could be that the clogging of the filters begins at the upper part of the filter element and moves downwards, whereby the liquid is forced through the filter closer at the outlet and therefore flows along the UV-lamps in shorter length.

Inside the filter elements, the UV-radiating means are placed, in the form of elongated UV-lamps placed inside quartz glass tubes. The filter elements are coated with catalytic material, alternatively made of catalytic material, and preferably also the inner surface of the housing. Thus the filter elements with the catalysts are irradiated by the UV-lamps, whereby radicals are produced in the region adjacent the inner surface of the filter elements and in the region between the filter elements and the lamps where the water flows. Due to the preferably short gap of the slits or mesh, any particle passing through is very close to a catalytic surface and thereby surely exposed to radicals produced.

One problem with the present filter design is that when the filter elements are clogged, the water is forced downwards along the filter elements before it can pass through. This means that the flow length between the filter element and the lamp becomes shorter and shorter, and thus the time the water is exposed to UV light. This then means that there is a risk that some contaminants, particles, organisms and the like in the water may pass without being eliminated when exposed to the AOT-process.

Of course this could to some extent be remedied with frequent backflushing of the filter elements. However, the backflushing operation entails interruption of the filtering and treatment process, which can be very undesirable when large quantities of water are to be treated in one operation.

One filter arrangement that is working together with UV light in order to purify liquids is disclosed in U.S. Pat. No. 4,971,687. It comprises a filter solution where the flow, independent of the degree of clogging of the filter, is forced to radically change the direction because of a flow controlling tube surrounding an elongated UV generating source. The flow controlling tube is placed in this position in order to force the flow along the UV source independent of the condition of the filter. This design entails a major pressure drop over the filter during all condition and in particular if the filter in addition is becoming clogged. There is no mention in U.S. Pat. No. 4,971,687 regarding the problems associated with clogging of filters and in particular clogging of elongated tubular filter elements. There is further no mention of catalytic surfaces in order to create radicals as treatment components.

### BRIEF DESCRIPTION OF THE INVENTION

The aim of the present invention is to remedy the above mentioned drawbacks. This aim is solved by the features of the independent patent claims. Preferable embodiments form the subject of the dependent patent claims.

According to a main aspect of the invention, it is characterised by an arrangement to be used in a liquid treatment unit, which unit comprises a generally tubular housing having a liquid inlet in one end of said housing and a liquid outlet in the opposite end of said housing, a generally tubular filter element arranged generally concentric inside said housing, through which the liquid is to be fed from outside the filter to inside the filter, an elongated UV-generating means arranged inside said filter element, the longitudinal direction of which generally corresponds to the longitudinal direction of the filter element, which UV-generating means is capable of generating UV light, material displaying catalytic properties arranged on at least the inner surfaces of said filter element, which material is radiated by said UV-light, characterised in that said elongated UV-generating means extends a further distance than said generally tubular filter element, which extension is positioned adjacent said outlet, wherein said further distance ensures the flow of liquid, that has passed through said filter element, to flow a certain minimum distance along said elongated UV-generating means, thereby exposing said flow of liquid to UV-light.

According to one alternative of the invention, said flow deflecting means comprises a generally tubular member, which tubular member forms an extension of said filter element in the region closest to said outlet.

According to another alternative of the invention, said flow deflecting means comprises a generally tubular member, which tubular member is arranged between said filter element and said elongated UV-generating means in the region closest to said outlet. In that respect, preferably said tubular member is of a UV-light permeable material.

According to yet an alternative of the invention, said flow deflecting means comprises a passage between the interior of said housing and said outlet, that said filter element is arranged with its end surface around said passage, and that said UV-generating means is positioned extending into said passage.

The present invention further comprises a filter comprising the above mentioned arrangement.

The filter preferably comprises material displaying catalytic properties comprises semiconductor material such as metal and/or metal oxides, such as noble metals, aluminium oxide, titanium oxide, silicon oxide or mixtures thereof.

Said filter element preferably is a wedge filter having slits in the region of 50 μm.

The advantages with the present invention are several. Due to the flow deflecting means inside the filter it is ascertained that the liquid flowing through the filter is exposed to radicals created by the UV generating means during a minimum period of time in that the liquid is forced to flow along the UV-generating means for a minimum length. Thereby, even though the filter element of the filter becomes clogged more and more, shortening the length the liquid is flowing along the UV-generating means, it is ensured that the liquid is sufficiently exposed so that any organisms in the liquid are exposed to the AOT-process.

The flow deflecting means could either be an extension of the filter element, but without any passages for the liquid, or a tubular member inside the filter element in the region of the outlet, forcing the liquid around the tubular member.

An important aspect of the present invention is that the filter extends through the casing of the device and that the UV generating means also is extending through the casing and is capable of radiating the whole inner surface of the filter and that the inlet and the outlet are arranged in opposite ends of the casing. This means that the flow through the device is predicable eve if the filter starts to clog. In order then to ascertain that the flow is exposed to radiation to an adequate extent a distance is created where the flow is not affected by the filter. With the design according to the invention a number of advantages are obtained in that the flow through the filter does not have to change direction, that one treatment part is placed outside the filter area and that the catalytic material on the filter surfaces directed towards the UV source is promoting the production of radicals. Thus, the present invention ascertains a proper function regarding purification with radicals even if the filter surfaces are beginning to clog, but as long as the majority of the filter surfaces are not clogged, the flow functions in an ordinary way.

These and other aspects of and advantages with the present invention will become apparent from the following detailed description and from the accompanying drawings.

### BRIEF DESCRIPTION OF THE DRAWINGS

In the following detailed description of the invention, reference will be made to the accompanying drawings, of which

FIG. 1 is a cross-sectional view of a filter comprising a first embodiment of the present invention,

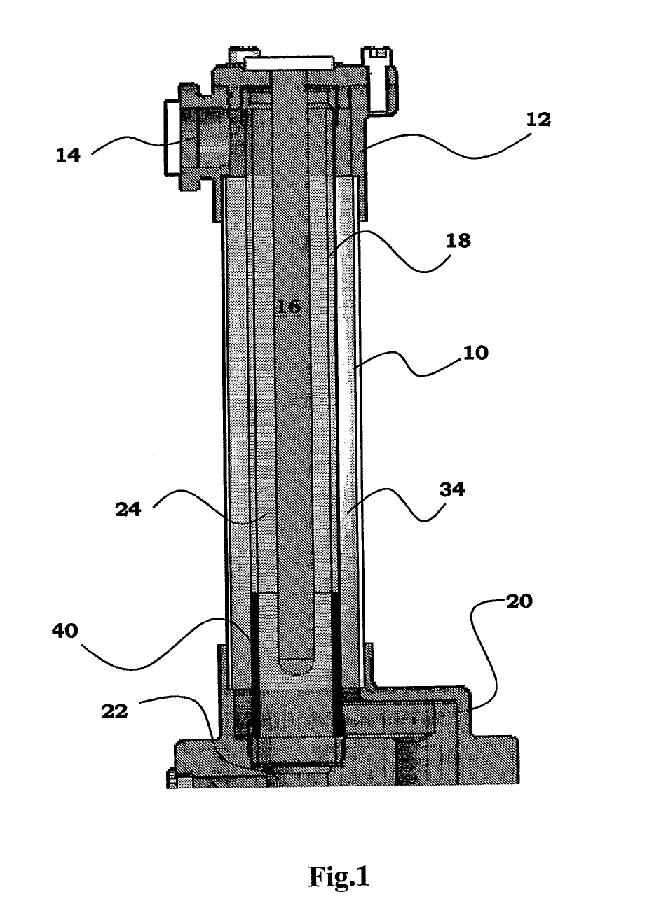

FIG. 2 is a detailed cross-sectional view of a second embodiment of the present invention,

FIG. 3 is a detailed cross-sectional view of a third embodiment of the present invention, and

FIG. 4 shows an example of connection of several filters comprising the present invention.

### DETAILED DESCRIPTION OF THE INVENTION

The filter shown in the drawings comprises a generally elongated tubular housing 10. One end of the housing is arranged with an end piece 12 comprising an inlet 14 for the water to be treated. The end piece is further arranged with a fixation piece for a generally elongated tube 16 made of a light permeable material such as quartz glass. Suitable sealing members are arranged between the glass tube and the end piece. Inside the glass tube a generally elongated UV-radiation source is arranged. Outside the glass tube, a filter element 18 is arranged, which also is attached to the end piece. According to one preferred embodiment, the filter is a so called wedge filter, wherein the filter element is arranged with a plurality of slits, generally arranged transversal to the longitudinal direction of the filter element. The slits have a wedge- or triangular shape as seen in cross-section. The width of the slits could for example be in the region of 50 μm, but other sizes are of course feasible depending on application. Further, the filter element is coated with material that displays photocatalytic properties, such as metal and/or metal oxides, such as noble metals, aluminium oxide, titanium oxide, silicon oxide and mixtures thereof.

The other end of the housing is also arranged with an end piece 20 comprising an outlet 22 for the treated water, which outlet is connected to the space 24 between the filter element and the glass tube. The outlet passage is arranged with a ball valve 26 for opening and closing the outlet. Further, the end piece preferably comprises passages and members capable of creating a back-flush operation of the filter elements.

During operation, water is led through the inlet 14 and passes the filter element 18 through the slits, whereby particles larger than about 50 μm are filtered off. The water is then exposed by the UV-radiation from the UV generating means 16 during the flow between the filter element and the glass tube towards and out of the outlet. This radiation of the water and the radiation of the catalytic surface of the filter element create radicals that are very efficient in killing off any organisms.

According to the present invention, the filter element is attached to a tubular member 40 at the lower region of the filter, i.e. closest to the outlet. The tubular member has completely solid walls, i.e. not letting through any water in this region of the filter. The aim of the tubular member is to force any water in this region between the tubular member and the housing upwards and through the filter element. This is especially important when the filter element becomes clogged during use. Since the inlet for the water to be treated is in the upper part of the filter, the upper part of the filter element is the first region to be clogged, forcing the water to flow downwards outside the filter element until it can pass through unclogged slits. In order to ascertain that the water that has passed through the filter element is exposed during a sufficiently long period of time it is assured that the water flow is exposed during a minimum length l along the UV-generating means, which is created by the tubular member.

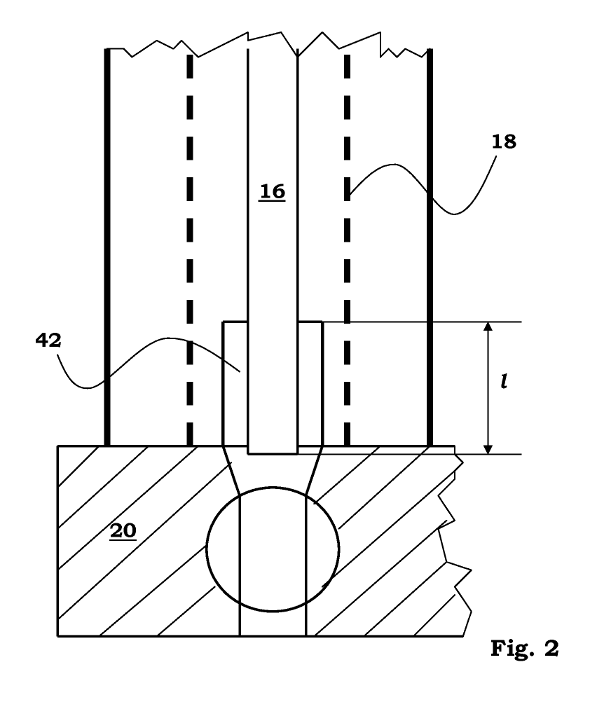

According to another variant of the present invention shown in FIG. 2, a tubular member 42 is arranged between the filter and the lamp in the lower region of the filter. Here the tubular member is of a light-permeable material whereby the whole inner surface of the filter element can be radiated by UV-light. With this solution the water that has passed through the filter in the lower region and is outside the tubular member is forced upwards and around the edge of the tubular member. In this way the water is forced to pass the UV-lamps during at least the length l of the tubular member.

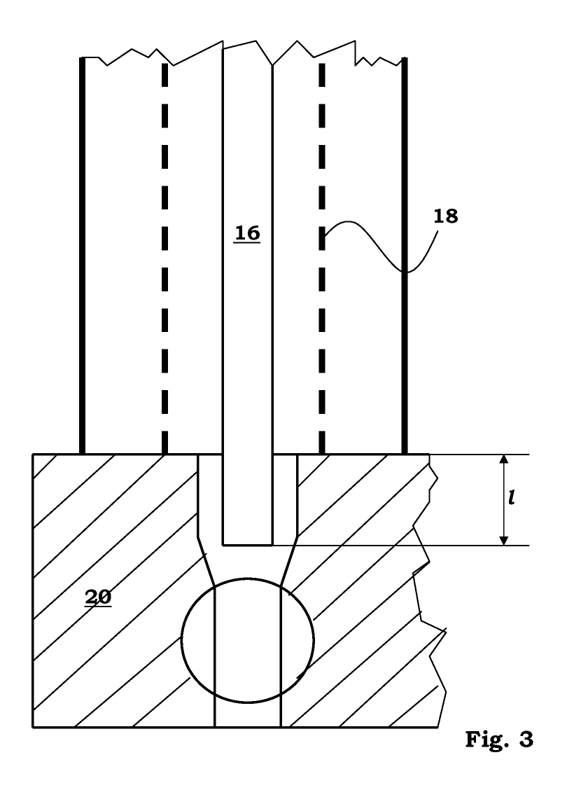

According to yet a variant of the invention shown in FIG. 3, the lower end piece, the UV-generating means and the filter housing may be designed such that the UV-lamps protrudes down into a cavity of the end piece, which cavity forms the minimum length l the water is forced to pass the UV-lamps.

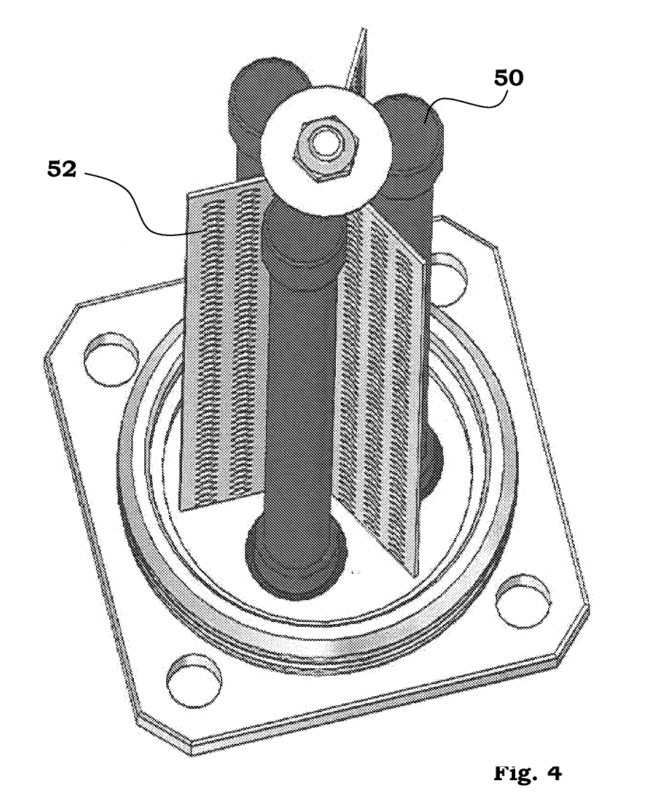

In order to further increase the productions of radicals and thereby increasing the treatment power of the filter, FIG. 4 shows another embodiment of the present invention wherein each filter element is arranged with three UV-generating means 50. Further, catalytic surfaces 52 are arranged between the UV-generating means. In order to further increase the amount of radicals produced, the photcatalytic surfaces are made corrugated or the like in order to increase the surface area.

It is to be understood that the embodiments described above and shown in the drawings are to be regarded only as non-limiting examples of the present invention and that it may be modified in many ways within the scope of the patent claims. Thus the filter element may have other forms, passages and size of passages depending on application.

1. Arrangement to be used in a liquid treatment unit, which unit comprises
a generally tubular housing having a liquid inlet in one end of said housing and a liquid outlet in the opposite end of said housing,
a generally tubular filter element arranged generally concentric inside said housing, through which the liquid is to be fed from outside the filter to inside the filter,
an elongated UV-generating means arranged inside said filter element, the longitudinal direction of which generally corresponds to the longitudinal direction of the filter element, which UV-generating means is capable of generating UV light,
material displaying catalytic properties arranged on at least the inner surfaces of said filter element, which material is radiated by said UV-light, characterised in that said elongated UV-generating means extends a further distance than said generally tubular filter element, which extension is positioned adjacent said outlet, wherein said further distance ensures the flow of liquid, that has passed through said filter element, to flow a certain minimum distance along said elongated UV-generating means, thereby exposing said flow of liquid to UV-light.

2. Arrangement according to claim 1, wherein said flow deflecting means comprises a generally tubular member, which tubular member forms an extension of said filter element in the region closest to said outlet.

3. Arrangement according to claim 1, wherein said flow deflecting means comprises a generally tubular member, which tubular member is arranged between said filter element and said elongated UV-generating means in the region closest to said outlet.

4. Arrangement according to claim 3, wherein said tubular member is of a UV-light permeable material.

5. Arrangement according to claim 1, wherein said flow deflecting means comprises a passage between the interior of said housing and said outlet, that said filter element is arranged with its end surface around said passage, and that said UV-generating means is positioned extending into said passage.

6. Filter comprising the arrangement according to claim 1.

7. Filter according to claim 6, wherein the material displaying catalytic properties comprises metal and/or metal oxides, such as noble metals, aluminium oxide, titanium oxide, silicon oxide or mixtures thereof.

8. Filter according to claim 6, wherein said filter element is a wedge filter having slits in the region of 50 μm.

9. Filter according to claim 1, wherein said UV-generating means is capable of emitting light at least in the region 185 and 254 nm.

10. Filter according to claim 6, wherein it further comprises an outlet for backflush liquid.

11. Filter according to claim 7, wherein said filter element is a wedge filter having slits in the region of 50 μm.
